(19) United States
(12) Patent Application Publication
(10) Pub. No.: US 2018/0354813 A1
(43) Pub. Date: Dec. 13, 2018

(54) APPARATUS AND METHODS FOR RELOCATING ICE PRODUCED BY DESALINATION AND MINERAL REDUCTION OF WATER RESOURCES BY VERTICAL FREEZING

(71) Applicant: Jai H. Rho, Branford, CT (US)

(72) Inventor: Jai H. Rho, Branford, CT (US)

(21) Appl. No.: 16/104,891

(22) Filed: Aug. 18, 2018

Related U.S. Application Data
(63) Continuation-in-part of application No. 15/079,310, filed on Mar. 24, 2016, now Pat. No. 10,099,943.

(51) Int. Cl. C02F 1/22; B01D 9/00

(52) U.S. Cl. CPC C02F 1/22; B01D 9/0009; C02F 2103/08; B01D 2009/0086; B01D 9/0059

(57) ABSTRACT

Apparatus and methods are disclosed for relocating blocks of ice produced by freezing contained water in a downward vertical direction in order to separate, minerals, organic matter and other impurities from seawater, brackish water, wastewater or other water resources. Generally, salt and other impurities will be rejected into feed water below the frozen water and may be drained from the tank through a drain pipe after a block of ice is formed. Additional feed water may then be pumped into the tank to raise the block of ice for removal or ejection from the tank. Surfaces of the block of ice that contact the tank may be heated to facilitate relocation of the block of ice.

### CROSS-REFERENCE TO RELATED APPLICATION

This is a continuation-in-part of application Ser. No. 15/079,310, filed Mar. 24, 2016.

### BACKGROUND

Approximately 70% of the Earth's surface is covered by water. However, only a small fraction of the world's water supply is naturally accessible as freshwater for household, agricultural, industrial, environmental and other purposes. The primary source of freshwater is currently atmospheric precipitation, mostly as rainfall or snowfall, which is captured in surface and underground structures and formations such as lakes, reservoirs, aquifers, watersheds, snowpack and glaciers.

Significantly, recent changes in climactic conditions have led to reduced atmospheric precipitation in many geographical areas where freshwater has historically been captured or utilized—resulting in severe droughts, depletion of supply, environmental harm, excess demand and other undesired consequences. Moreover, increasing population in these and other locations has accelerated the effects of reduced freshwater availability and contributed to a growing need for additional or alternative sources of freshwater.

Traditional responses to shortages and fluctuations in freshwater supply have included conservation, rationing, recycling and wastewater treatment, among others. While these approaches may be helpful in providing near term adjustments to changing conditions, they do not increase the overall supply of freshwater. Other conventional solutions have included construction of large dams, reservoirs and other facilities for capture and storage of freshwater, but such solutions are dependent upon favorable climactic conditions and limited by geological, structural and other factors. Additionally, freshwater has been transported from particular resources or regions to others through pipelines, aqueducts, tunnels and canals, but these methods generally diminish overall supply through evaporation, seepage and other loss, and may result in environmental or other harm to areas where water is removed, diverted or transported.

Desalination of seawater or brackish water has also been utilized to provide additional or alternative supplies of freshwater. The primary methods of desalination have generally been distillation or filtration, which typically require substantial energy consumption and complex facilities and infrastructure. As an example, multi-stage flash distillation (MSF) is a thermal process that involves heating and sequential flash evaporation of feed water through a series of stages or chambers having lowered vapor pressures at successive stages. The evaporated feed water is condensed at each stage to form product water having reduced salinity and the remaining feed water is discharged as brine. A similar process to MSF is multiple-effect distillation (MED) which utilizes evaporated steam to heat feed water in successive stages through a series of connecting tubes. When feed water inside a chamber contacts a connecting tube filled with steam, the feed water partially evaporates and the steam inside the tube condenses to form product water. The remaining feed water is discharged as brine and the evaporated steam flows into the connecting tube of another chamber.

A widely used form of filtration involves reverse osmosis (RO) in which high pressure pumps overcome osmotic pressure to diffuse water molecules through selective pores of semi-permeable membranes that prevent passage of larger molecules such as salt, organic compounds and other solutes. Such membranes are typically layered with other materials that provide channels for separated flow of product water and brine, and are deployed inside pressure tubes in a spiral configuration during operation. Generally, feed water is only partially pumped through a membrane to provide product water while unfiltered feed water is used to flush away brine.

When solutes and other impurities accumulate inside the pressure tubes, the membranes may become fouled and must be cleaned or replaced by removal from the pressure tubes or other process. In order to reduce or minimize fouling of membranes, feed water often undergoes pretreatment in beach wells, sediment filters, carbon filtration, chemical treatment or other methods. The purity of product water may also be improved by re-pumping filtered feed water through membranes in multiple passes.

Another form of filtration utilizes electrodialysis (ED) by applying direct electrical current to feed water within a container having a stack of ion-exchange membranes. Positive sodium ions produced by dissolved salt molecules pass through cation membranes while negative chloride ions pass through anion membranes to convert the feed water into separate streams of brine and filtered water. This process is generally limited to low concentrations of saline water and is subject to fouling of membranes. In order to alleviate fouling, the electrical current may be reversed in a process known as electrodialysis reversal (EDR).

Freezing methods have also been used for desalination. Common techniques generally involve pumping a refrigerant, such as butane or carbon dioxide, directly into feed water within a crystallization unit to produce a slurry of brine and ice crystals. The slurry is then pumped to a wash unit in order to separate ice crystals from brine by using a liquid, such as freshwater, to wash the brine from the ice crystals. To facilitate separation, another liquid such as oil may be added in the wash unit or a separation column. Ice crystals are then transferred to a melter unit where they are melted to provide product water.

In some variations, slurry may be produced by vacuum, eutectic or clathrate processes. Vacuum freezing typically involves spraying feed water into a vacuum chamber where partial vaporization occurs and ice crystals are formed when the water loses heat. The ice crystals then mix with the remaining feed water to produce a slurry. Eutectic freezing generally facilitates separation of brine from ice crystals by forming salt crystals at a temperature where both salt and ice crystals may be formed. Salt crystals are more easily washed away from ice crystals than dissolved salt, which frequently becomes trapped during ice crystal formation. Clathrate freezing may also be used to facilitate separation of brine from ice crystals by using hydrocarbons such as methane, ethane or butane to form hydrates that block salt from becoming trapped inside molecular cages of ice.

Other freezing techniques have used heat exchangers such as tubes, drums or plates for progressive growth of ice crystals along a surface on the opposite side of a wall containing a refrigerant such as ethylene glycol. As an example, feed water may be pumped into a crystallization chamber, such as a tube or drum, that is immersed in a coolant bath so that ice crystals may grow along the internal surface of the crystallization chamber. The crystallization chamber is then removed from the coolant bath so that the ice crystals may be melted to provide product water. Conversely, a refrigerant may be pumped into a tube that is immersed in a tank of feed water so that ice crystals may grow along the external surface of the tube. The tube is then removed from the tank along with the ice, and product water is produced by melting the ice.

### SUMMARY OF THE INVENTION

The present invention generally relates to the field of water desalination, and more particularly, to apparatus and methods for relocating blocks of ice produced by freezing contained water in a downward vertical direction to separate salts, minerals, organic matter and other impurities from seawater, brackish water, wastewater or other water resources.

In one embodiment, feed water is pumped through a water intake pipe into a tank having an opening for a refrigerant to contact the upper surface of the feed water and form a layer of ice. During this process, salt and other impurities are rejected from the ice layer into the feed water below. By continuing this process, the feed water will freeze in a downward vertical direction as the ice layer thickens. Salt and other impurities will continue to be rejected into the feed water and may be drained from the tank through a drain pipe after a block of ice is formed. Additional feed water may then be pumped into the tank to raise the block of ice through the opening in the tank for removal by a push rod, moveable arm or other mechanical device. Surfaces of the block of ice that contact the tank may be heated to facilitate relocation of the block of ice. The block of ice may then be melted to provide product water.

In another embodiment, feed water is pumped through a water intake pipe into an enclosed tank having a refrigerant intake and exhaust pipe for supplying a refrigerant into the upper portion of the enclosed tank. The feed water is then frozen in a downward vertical direction until a block of ice is formed, and rejected salt and other impurities may be drained from the enclosed tank through a drain pipe. Additional feed water may be pumped into the enclosed tank to raise the block of ice and displace the refrigerant from the enclosed tank through the refrigerant intake and exhaust pipe. Surfaces of the block of ice that contact the tank may be heated to facilitate relocation of the block of ice. A panel of the enclosed tank is then opened to allow the block of ice to be removed from the enclosed tank and the displaced refrigerant may be used to eject the block of ice from the enclosed tank with positive pressure. The panel is then closed and additional refrigerant may be drawn into the enclosed tank with negative pressure by partially draining the additional feed water through the drain pipe.

These embodiments, as well as others, may utilize a doubled-walled tank to provide an insulation chamber between internal and external walls of the tank. An insulation fluid, such as air or oil, may be pumped into the insulation chamber to control the temperature of the internal wall of the tank and insulate the feed water from the refrigerant along the surface of the internal wall. Such insulation will facilitate freezing of the feed water in a downward vertical direction. After a block of ice is formed, the temperature of the insulation chamber may be increased to melt the surfaces of the block of ice that contact the internal wall of the tank in order to facilitate vertical movement of the block of ice. Such movement should occur when the block of ice is raised by additional feed water for removal or ejection of the block of ice from the tank.

Multiple tanks may also be utilized to increase the efficiency, scale and volume of production. They may be positioned adjacent to a conveyor platform that receives blocks of ice from the tanks and convey the blocks of ice by mechanical devices such as motorized belts or rollers, or by active flow of a liquid such as freshwater. The conveyor platform may also be inclined to use gravitational force. Further, multiple tanks may be arranged in multiple levels with multiple conveyor platforms and shared pipes.

Although several embodiments of the present invention are disclosed, it should be understood that other variations, modifications, equivalents and embodiments may be made or used by those skilled in the art without departing from the scope and spirit of the present invention.

### BRIEF DESCRIPTION OF THE DRAWINGS

FIG. 1 is a schematic view of an apparatus for freezing water in a downward vertical direction.

FIG. 2 is a schematic view of the apparatus shown in FIG. 1, further showing a refrigerant supplied to the upper surface of feed water contained in the apparatus.

FIG. 3 is a schematic view of the apparatus shown in FIG. 1, further showing a block of ice formed by freezing water in a downward vertical direction.

FIG. 3A is a schematic view of the apparatus shown in FIG. 1, further showing a heating coil for melting surfaces of the block of ice.

FIG. 4 is a schematic view of the apparatus shown in FIG. 1, further showing a block of ice raised by additional feed water for removal by a mechanical device.

FIG. 5 is a schematic view of another embodiment of an apparatus for freezing water in a downward vertical direction.

FIG. 5A is a schematic view of the apparatus shown in FIG. 5, further showing a heating coil for melting surfaces of the block of ice.

FIG. 6 is a schematic view of the apparatus shown in FIG. 5, further showing a block of ice raised by additional feed water for ejection by a refrigerant with positive pressure.

FIG. 7 is a schematic view of the apparatus shown in FIG. 5, further showing an insulation chamber for insulating the feed water from the refrigerant and melting surfaces of the block of ice to facilitate vertical movement.

FIG. 7A is a schematic view of the apparatus shown in FIG. 7, further showing a condenser and heat exchanger for supplying waste heat to the insulation chamber to melt surfaces of the block of ice.

### DETAILED DESCRIPTION

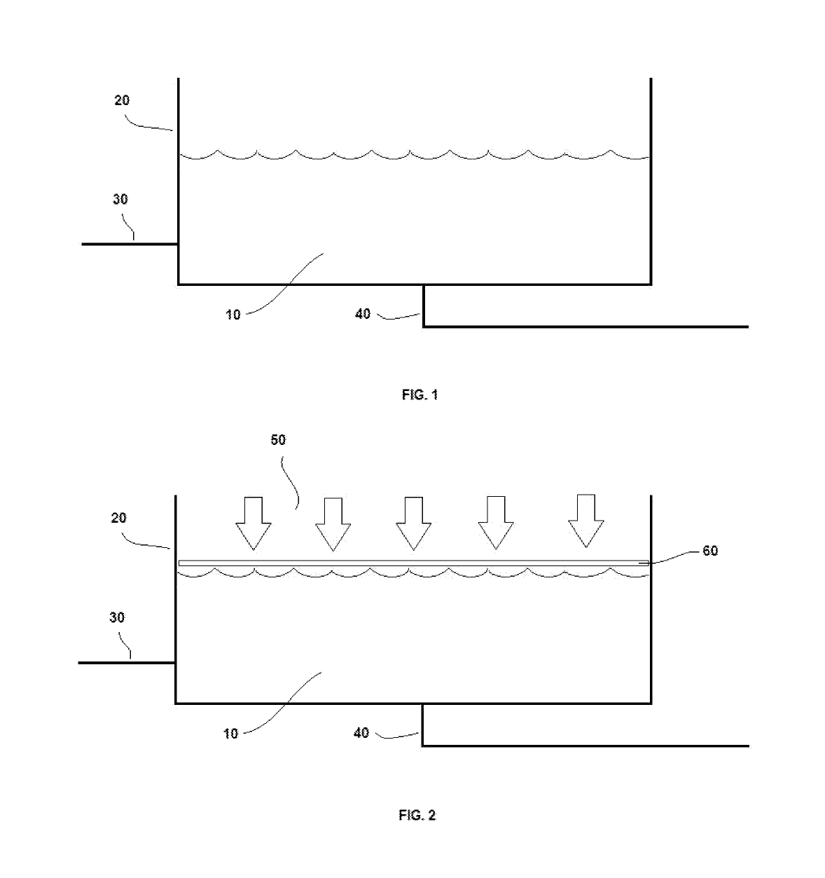

Referring to FIG. 1, feed water 10 from a water resource such as seawater, brackish water or wastewater is pumped into a tank 20 through a water intake pipe 30 and discharged through a drain pipe 40. As shown in FIG. 2, a refrigerant 50 such as chilled air, nitrogen or oxygen is supplied to the upper surface of the water 10 contained in the tank 20 at an appropriate temperature to form a layer of ice 60. During this freezing process, water molecules crystallize to form a lattice structure which allows the ice layer 60 to float on top of the water 10 while rejecting salt, organic compounds, minerals or other impurities into the water 10 beneath the layer of ice 60.

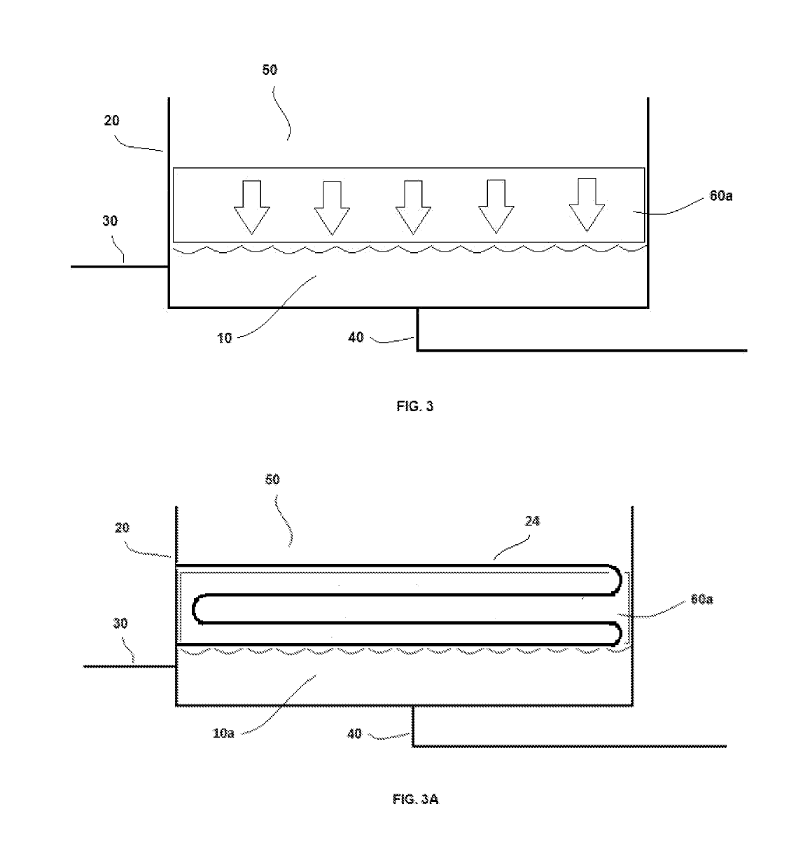

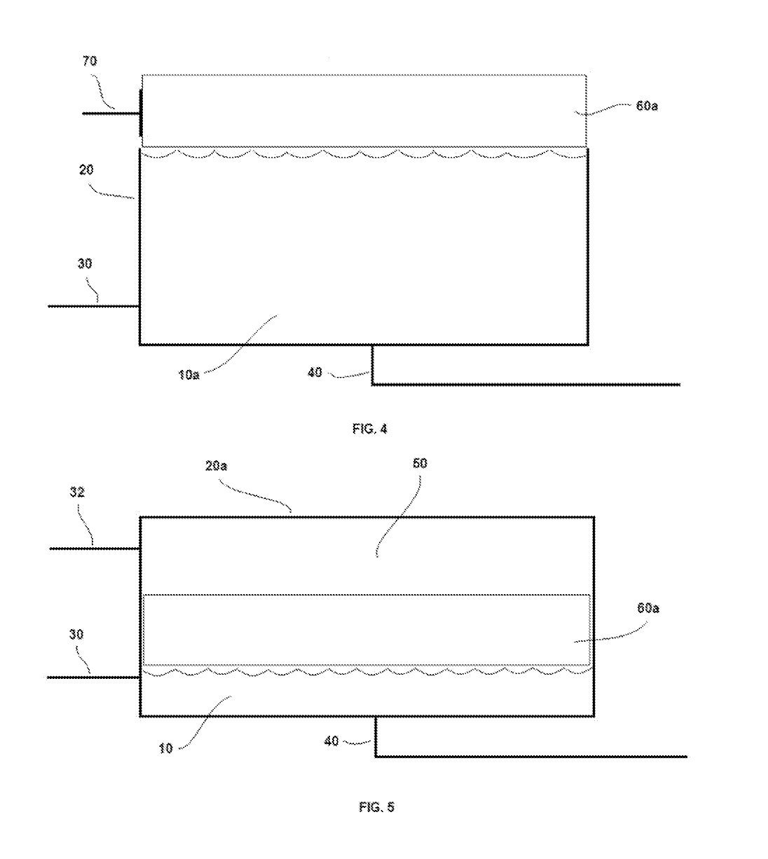

Referring to FIG. 3, the temperature of the refrigerant 50 is indirectly transferred through the layer of ice 60 to continuously freeze the water 10 in a downward vertical direction until a block of ice 60a is formed. Impurities are then discharged with the remaining water 10 through the drain pipe 40. As shown in FIG. 4, feed water 10a is then pumped into the tank 20 to raise the block of ice 60a above at least one wall of the tank 20 and a mechanical device such as a push rod 70 or moveable arm is used to remove the block of ice 60a from the tank 20. The block of ice 60a is then melted to provide product water. As shown in FIG. 3A, a heating coil 24 is used to melt surfaces of the block of ice 60a that contact the tank 20 in order to facilitate relocation of the block of ice 60a while it is being raised by feed water 10a for removal from the tank 20.

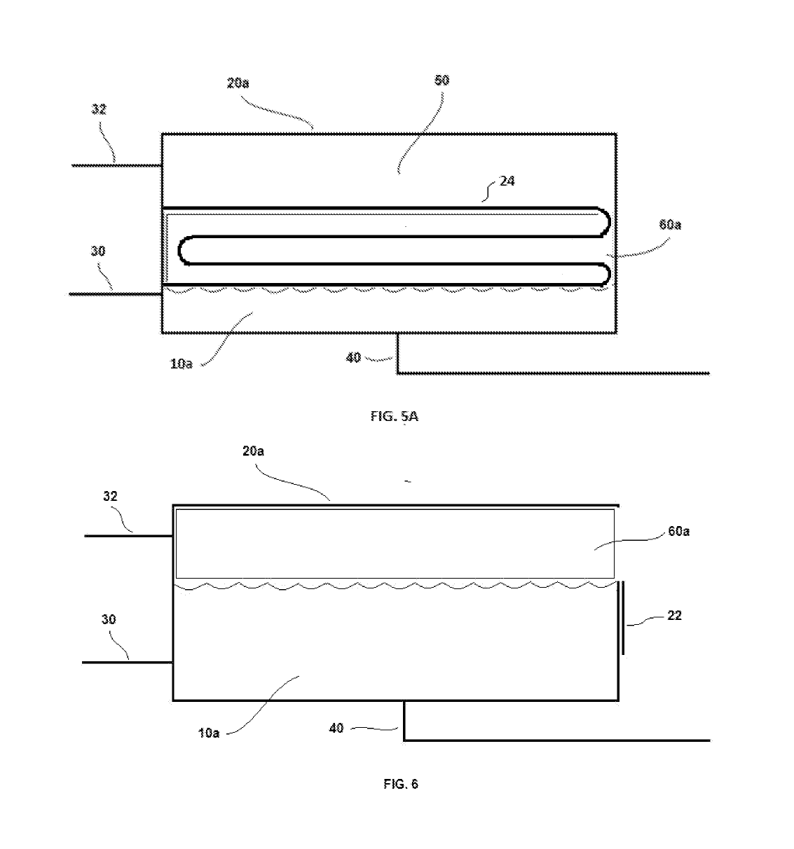

In an alternative embodiment, shown in FIG. 5, feed water 10 is pumped into an enclosed tank 20a through a water intake pipe 30 and discharged through a drain pipe 40. Refrigerant 50 is pumped into the enclosed tank 20a through a refrigerant intake and exhaust pipe 32, which may consist of separate pipes. As in the previous embodiment, the refrigerant 50 freezes the contained water 10 to form a block of ice 60a. After rejected impurities are discharged with the remaining water 10 through the drain pipe 40, additional feed water 10a is pumped into the enclosed tank 20a to raise the block of ice 60a, as shown in FIG. 6. During this process, the block of ice 60a displaces the refrigerant 50 out of the enclosed tank 20a and the refrigerant is removed through the refrigerant intake and exhaust pipe 32. A panel 22 of the enclosed tank 20a is then opened, for example by swinging or sliding the panel, to enable the block of ice 60a to be removed from the enclosed tank 20a. The displaced refrigerant 50 is then pumped or otherwise supplied back into the enclosed tank 20a through the refrigerant intake and exhaust pipe 32 to eject the block of ice 60a out the opening of panel 22 with positive pressure. After the block of ice 60a is completely outside the tank 20a, the panel 22 is closed. In this manner, the refrigerant 50 may be recycled or recirculated in order to reduce or minimize the amount of energy required to form multiple blocks of ice 60a. The feed water 10a may also be partially drained through the drain pipe 40 to draw additional refrigerant 50 into the tank 20a through the refrigerant intake and exhaust pipe 32 with negative pressure after the ice block 60a has been ejected.

As shown in FIG. 5A, a heating coil 24 is used to melt surfaces of the block of ice 60a that contact the tank 20a in order to facilitate relocation of the block of ice 60a while it is being raised by feed water 10a for removal from the tank 20a.

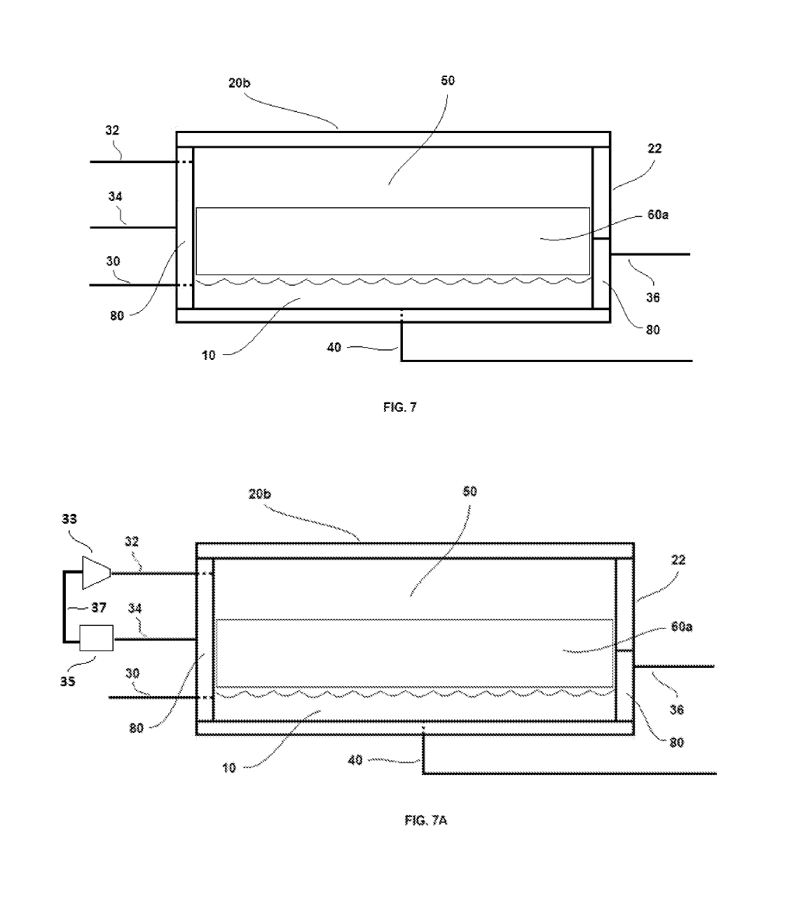

FIG. 7 shows another embodiment of the present invention with a double-walled tank 20b having an insulation chamber 80 between internal 26 and external 28 walls of the tank 20b. A fluid, such as oil or air, is pumped into the insulation chamber 80 through an insulation intake pipe 34 in order to control or modify the temperature of the internal walls. When the temperature of the internal walls is higher than the temperature of the water 10 contained inside the tank 20b, the water 10 will be insulated from the refrigerant 50 along the internal walls. This insulation will allow the refrigerant 50 to freeze the upper surface 60 of the water 10 in a downward vertical direction to form a block of ice 60a. After the block of ice 60a is formed, the temperature of the internal walls may be increased to facilitate vertical movement of the block of ice 60a by pumping a higher temperature fluid through the insulation intake pipe 34 and purging or removing the lower temperature fluid through an insulation exhaust pipe 36. The increased temperature of the internal walls will facilitate vertical movement of the block of ice 60a by melting the surfaces of the block of ice 60a that contact the internal walls. As in the previously described embodiments, the block of ice 60a is raised by pumping additional feed water 10a into the tank 20b and then removed by opening the panel 22 and pumping the refrigerant 50 into the tank 20b to eject the block of ice 60a outside the tank 20b with positive pressure. As shown in FIG. 7A, waste heat from a compressor 33 is pumped through a waste heat pipe 37 to a heat exchanger 35 to provide a high temperature fluid to the insulation chamber 80 to melt surfaces of the ice block 60a that contact the internal walls of the tank 20b.

While several embodiments of the present invention have been described above, it should be understood that other variations, modifications, equivalents and embodiments may be made or used by those skilled in the art without departing from the scope and spirit of the present invention.

I claim:

1. An apparatus for separating salt, minerals, organic matter or other impurities from seawater, brackish water, wastewater or other water resource, comprising:
at least one tank having at least one opening for supplying a refrigerant to an upper portion of said tank, wherein at least one block of ice is raised through said opening of said tank by supplying additional feed water into said tank;
at least one water intake pipe connected to said tank for supplying feed water into said tank;
at least one drain pipe connected to said tank for draining a portion of said feed water from said tank; and
at least one heating coil affixed to said tank for melting surfaces of said block of ice that contact said tank.

2. An apparatus for separating salt, minerals, organic matter or other impurities from seawater, brackish water, wastewater or other water resource, comprising:
at least one enclosed tank having at least one panel which is opened and closed;
at least one refrigerant intake pipe connected to said enclosed tank for supplying refrigerant to an upper portion of said enclosed tank;
at least one water intake pipe connected to said enclosed tank for supplying feed water into said tank;
at least one drain pipe connected to said tank for draining a portion of said feed water from said enclosed tank; and
at least one heating coil affixed to said tank for melting at least one surface of at least one block of ice, wherein said block of ice is raised by supplying additional feed water into said enclosed tank.

3. An apparatus for separating salt, minerals, organic matter or other impurities from seawater, brackish water, wastewater or other water resource, comprising:
at least one enclosed tank having at least one panel which is opened and closed, wherein said enclosed tank has at least one insulation chamber between at least one internal wall and at least one external wall of said enclosed tank;
at least one refrigerant intake pipe connected to said enclosed tank for supplying refrigerant to an upper portion of said enclosed tank;
at least one water intake pipe connected to said enclosed tank for supplying feed water into said tank;
at least one drain pipe connected to said tank for draining a portion of said feed water from said enclosed tank; and
at least one insulation intake pipe connected to said insulation chamber for supplying a fluid to control the temperature of said internal wall, wherein waste heat from a condenser is supplied to a heat exchanger connected to said insulation intake pipe to heat said fluid.

10. A method for separating salt, minerals, organic matter or other impurities from seawater, brackish water, wastewater or other water resource, comprising:
supplying feed water into at least one tank;
freezing said feed water in a downward vertical direction by supplying a refrigerant to the upper surface of said feed water;
draining brine from said tank after at least one block of ice is formed by said freezing of said feed water; and
supplying additional feed water into said tank to raise said block of ice, wherein at least one surface of said block of ice is melted before said block of ice is raised.

11. A method according to claim 10, wherein said enclosed tank further comprises at least one insulation chamber between at least one internal wall and at least one external wall of said enclosed tank and a fluid is supplied into said insulation chamber to control the temperature of said internal wall.

12. A method according to claim 11, wherein said internal wall is heated by a fluid in said insulation chamber to melt at least one surface of said block of ice along said internal wall.

13. A method according to claim 12, wherein waste heat from a condenser is used to heat said fluid.
